(19) United States
(12) Patent Application Publication
(10) Pub. No.: US 2006/0102234 A1
(43) Pub. Date: May 18, 2006

(54) Device for creating a pulsating flow of gas or fluid

(76) Inventor: David Meisel, Bloomfield Township, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/264,485

(22) Filed: Nov. 1, 2005

Related U.S. Application Data
(60) Provisional application No. 60/628,627, filed on Nov. 17, 2004.
(60) Provisional application No. 60/630,923, filed on Nov. 24, 2004.

(51) Int. Cl. F16K 15/04

(52) U.S. Cl. 137/539

(57) ABSTRACT

A flow control device that creates a pulsating flow includes a body with a flow passage defined therethrough. The device further includes a flow interruption element having a flow interrupting position and an open position and a biasing element that biases the flow interruption element into the flow interrupting position. A flow of gas or fluid passing through the flow passage impinges on the flow-interrupting member causing the flow interrupting member to intermittently move between the flow interrupting position and the open position, thereby intermittently allowing the flow of gas or fluid to pass the flow interrupting element. This creates a pulsating flow of gas or fluid.

### REFERENCE TO RELATED APPLICATIONS

This application claims priority to U.S. Provisional Patent Application Ser. No. 60/628,627, filed Nov. 17, 2004 and 60/630,923, filed Nov. 24, 2004, the entire content of both of which are incorporated herein by reference.

### FIELD OF THE INVENTION

The present invention relates generally to fluid control devices and, more specifically, to a device for pulsating a flow of gas or fluid.

### BACKGROUND OF THE INVENTION

Flows of fluids or compressed air are used in a wide variety of applications, especially for cleaning and removal of dust and debris. For example, it is typical to use a flow of compressed air to blow dust or debris from a workpiece following a finishing operation, such as sanding. It is also known to provide streams of compressed air to clean the clothing of a person entering a clean room environment. A vacuum may also be used for cleaning. While these approaches are moderately effective, there remains a need for improved approaches to cleaning and flow control.

### SUMMARY OF THE INVENTION

The present invention provides a flow control device that creates a pulsating flow, which has been found to be beneficial for cleaning with a flow of fluid or compressed gas, and for other applications. The device according to the present invention includes a body with a flow passage defined therethrough. The device further includes a flow interruption element having a flow interrupting position and an open position and a biasing element that biases the flow interruption element into the flow interrupting position. A flow of gas or fluid passing through the flow passage impinges on the flow interrupting member causing the flow interrupting member to intermittently move between the flow interrupting position and the open position, thereby intermittently allowing the flow of gas or fluid to pass the flow interrupting element. This creates a pulsating flow of gas or fluid. The flow interrupting member may be a ball that rests against a seat in the flow passage when it is in the flow interrupting position, and the biasing means may be a spring that biases the ball into the flow interrupting position. Alternatively, the flow interrupting member and biasing member may be combined into a reed-like member that rests against a seat when in the flow interrupting position and which is flexed away from the seat when in the open position. Other variations are also disclosed herein.

The present invention also provides a number of devices making use of a pulsating flow of gas or fluid. Other variations and distinct inventions are also illustrated and discussed herein.

### BRIEF DESCRIPTION OF THE DRAWINGS

FIG. 1a is a cross-sectional view of a first embodiment of a device for creating a pulsating flow of gas or liquid, according to the present invention;

FIG. 1b is a cross-sectional view of the device of FIG. 1a with the flow interrupting ball in the flow interrupting position;

FIG. 1c is a cross-sectional view of the device of FIGS. 1a and 1b with the flow interrupting ball in the open position;

FIG. 2a is a cross-sectional schematic of an alternative fluid control device according to the present invention in a first position;

FIG. 2b is a cross-sectional view of the fluid control device of FIG. 19 in a second position.

FIG. 3a is a cross-sectional view of an alternative embodiment of a device for creating a pulsating flow of gas or liquid according to the present invention;

FIG. 3b is a cross-sectional view of the device of FIG. 3a with the flow interrupting reed-like element in the flow interrupting position; FIG. 3c is a cross-sectional view of the device of FIGS. 3a and 3b with the reed-like element flexed away from the seat into the open position;

FIG. 4, is a cross sectional view of a further embodiment of a device for creating a pulsating flow of gas or liquid;

FIG. 5 is a cross sectional view of an alternative embodiment utilizing magnets;

FIG. 6 is a cross sectional view of another alternative embodiment utilizing a coil;

FIG. 7 is a cross sectional view of yet another alternative embodiment with two coils;

FIG. 8 is a cross sectional view of an embodiment utilizing a slug as a flow interrupting element;

FIG. 9A is a cross sectional view of an embodiment with a coil around a slug and a full wave bridge to convert AC to DC;

FIG. 9B is a schematic of a full wave bridge;

FIG. 10 is a cross sectional view of an alternative embodiment with a coil around a slug;

FIG. 11 is a cross sectional view of an alternative embodiment with a turbine generator in the passage;

FIG. 12 is a view of an embodiment of a drill bit with a fluid control device according to the present invention;

FIG. 13 is a view of a drill head with a fluid control device according to the present invention;

FIG. 14 is a view of a vacuum cleaner with a portion cut away, showing a fluid control device according to the present invention;

FIG. 15 is a view of a vacuum cleaner with a portion cut away showing a fluid control device according to the present invention;

FIG. 16 is a view of a spray can, partially cut away to show a fluid control device according to the present invention disposed therein;

FIG. 17 is a view of a spray can similar to FIG. 14 but with agitating fins extending into the fluid to be sprayed;

FIG. 18 is a view of a spray gun with a portion partially cut away to show a fluid control device according to the present invention disclosed in the handle thereof;

FIG. 19 is a detailed view of a spray nozzle with parts cut away to show fluid control devices disposed therein; and

FIG. 20 is a cross-sectional view of a portion of an internal combustion engine with a fluid injector having a fluid control device according to the present invention disposed therein.

### DETAILED DESCRIPTION OF THE PREFERRED EMBODIMENTS

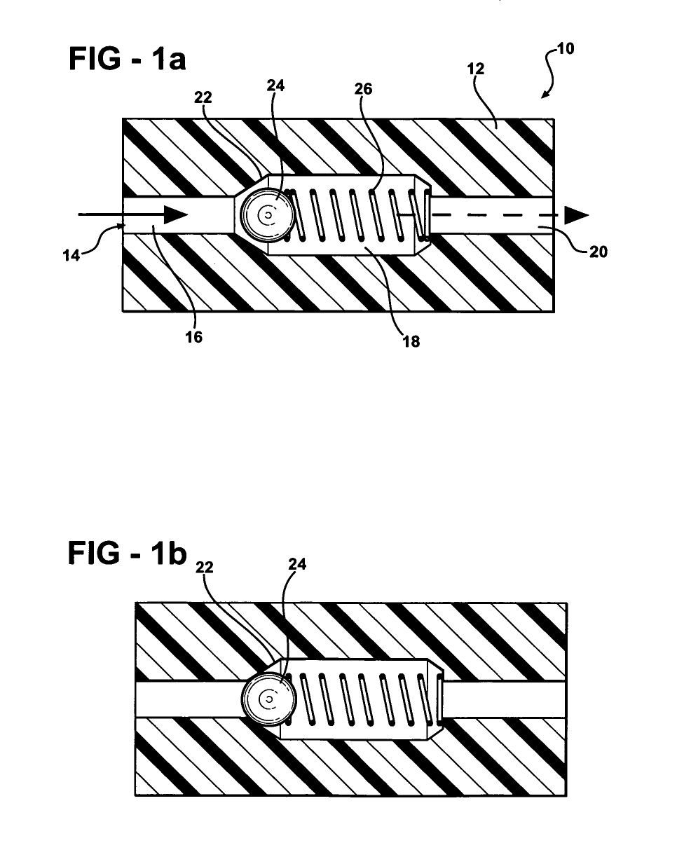

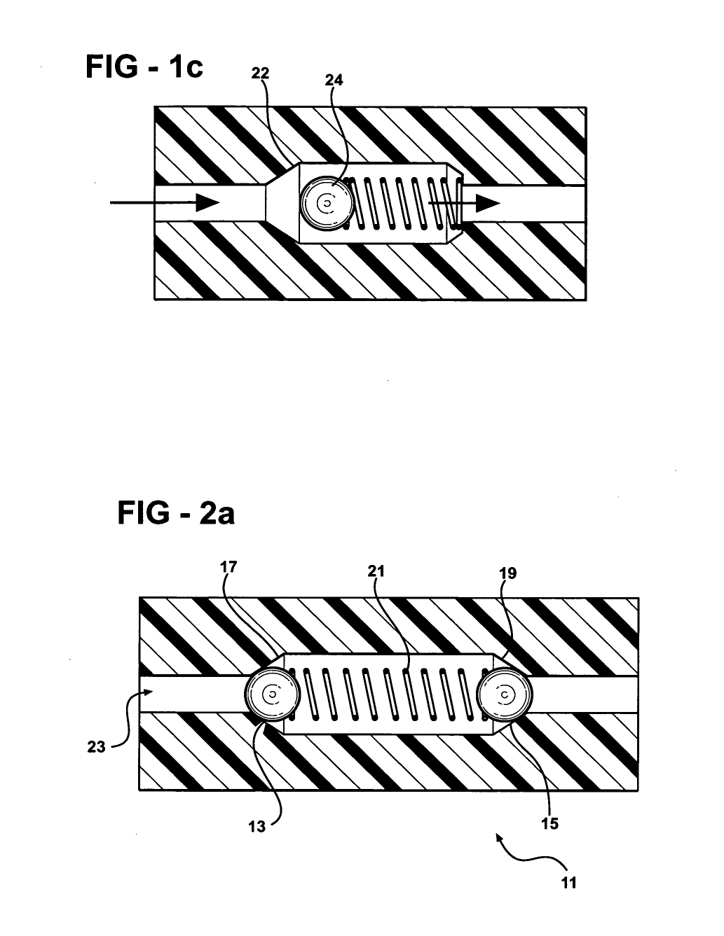

FIG. 1a illustrates a cross-sectional view of a first embodiment of a device for creating a pulsating flow of gas or liquid according to the present invention. The device 10 includes a body 12 with a flow passage 14 defined therethrough. The passage has an inlet portion 16, a central portion 18, and an outlet portion 20. The flow passage 14 in the body 12 is shaped so as to provide a seat at the entrance to the central portion 18. A check ball 24 is positioned adjacent the seat 22 and is biased towards the seat 22 by a biasing member such as spring 26, an electromagnetic or inductive field, or other means. A flow of gas or liquid, typically compressed air, enters the inlet portion of the flow passage 14 as indicated by the solid arrow. The flow of gas impinges on the check ball 24, which acts as a flow interrupting element. The flow of gas, if of sufficiently high pressure, will urge the check ball 24 against the biasing spring 26 so as to move the ball 24 away from the seat 22, as illustrated in FIG. 1a. As will be clear to those of skill in the art, if the spring force of the spring 26, the ball and seat shape, and pressure and flow of air are appropriately chosen, the check ball 24 will oscillate between a flow interrupting position wherein the ball 24 is against the seat 22 and an open position wherein it is spaced from the seat. FIG. 1b illustrates the ball 24 in the flow interrupting position wherein it is substantially sealed against the seat 22. FIG. 1c illustrates the check ball 24 in the fully open position wherein a flow of gas may pass around the ball 24. Alternatively, the ball may oscillate between a position closer to the seat and a position farther from the seat, wherein the ball does not contact the seat and/or completely block the flow when in the closer position. The spring and ball may be supported in a variety of ways. In one embodiment, the central portion of the flow passage is narrower than illustrated, such that the sides of the passage guide the ball. The tightness of this fit can be adjusted to adjust the characteristics of the device.

FIGS. 1a-1c should be considered schematic illustrations of the device 10. The sizes and shapes of the various elements of the device 10 may be altered in a variety of ways. In the illustrated embodiment, the inlet portion 16 and outlet portion 20 of the flow passage 14 are smaller than the central portion 18. These portions are also aligned with one another. The reduced diameter outlet portion 20 may not be required, though may be useful for increasing the velocity of pulsating flow. The ball and seat may be designed and shaped other than as illustrated, and may include a controlled leak around the ball to assist in initiating the oscillating behavior of the check ball. The device may also include adjustments, such as an adjustable support, an adjustable electromagnetic or inductive field, or other means, for adjusting the preload or stiffness of the spring so as to adjust the characteristics of the spring mass system.

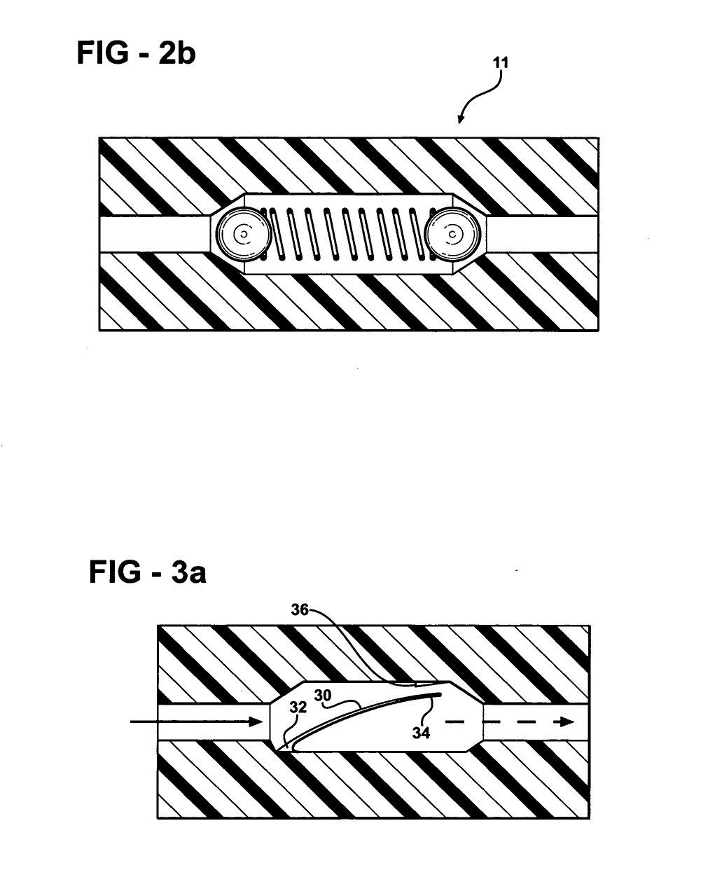

FIGS. 2a and 2b show an alternative fluid control device 11 with a pair of check balls 13 and 15 engaging seats 17 and 19 with a spring 21 extending between the balls 13 and 15. In the position shown in FIG. 2a, the balls are both in a closed position. As will be clear to those of skill in the art, the balls may be set into an oscillatory motion by the flow of gas through the passage 23. For example, as gas or fluid encounters the ball 13, it will be push the ball 13 away from the seat 17 thereby increasing the spring pressure in spring 21. The ball 15 should then oscillate back, thereby reducing the pressure in spring 21. If properly designed, the ball 15 will oscillate away from the seat 19 allowing the fluid to flow past the ball 15. If properly designed and tuned, the balls will continue to oscillate in some manner so as pulsate the flow. The balls may move into the position shown in FIG. 2b, wherein both are spaced from their seats as they oscillate through the motion.

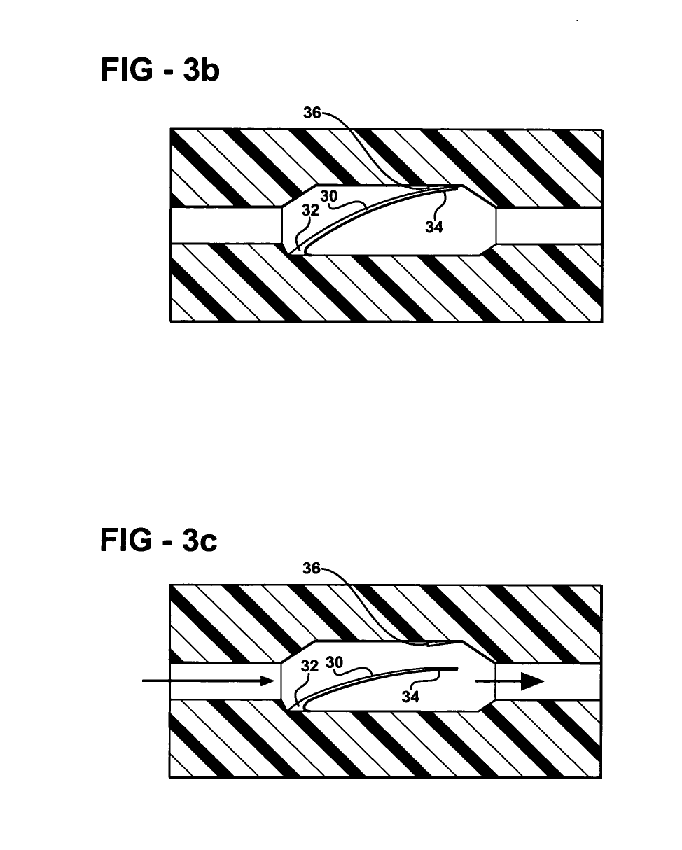

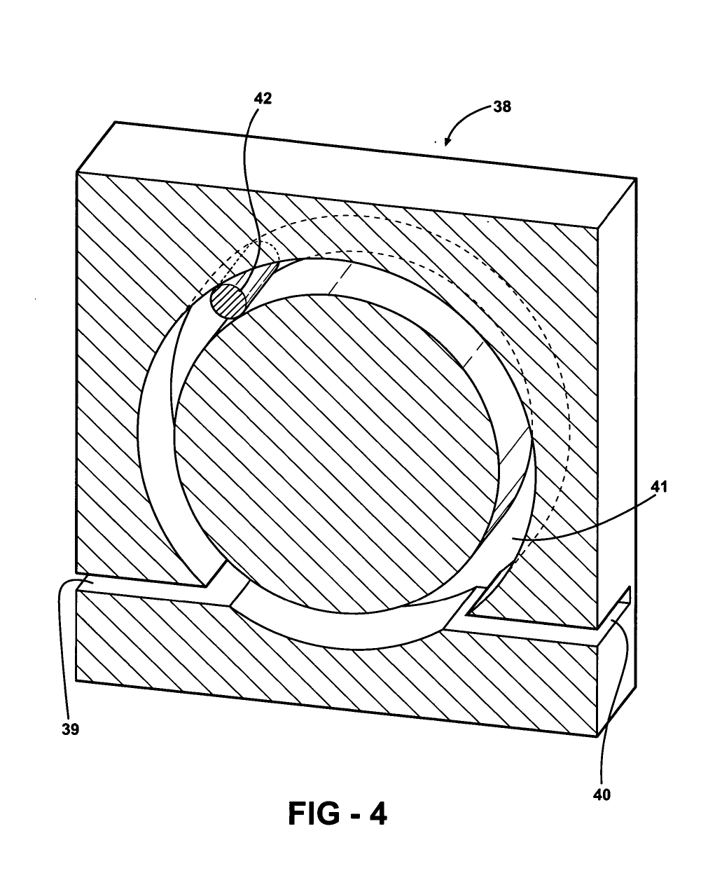

Turning now to FIGS. 3a-3c, an alternative embodiment is illustrated in which a reed-like element 30 with a base 32 attached to the side of the flow passage and a free end 34. The reed-like element 30 is flexible such that the free end 34 either contacts a seat 36, thereby partially or completely closing off the flow passage, and a position wherein the end 34 is spaced from the seat 36 so as to allow the passage of gas or liquid. The reed-like member 30 is designed such that the free end 34 is biased into the flow interrupting position, wherein it is against the seat 36. FIG. 3b illustrates the reed-like member in the flow interrupting position, while FIG. 3c illustrates the reed-like member in the open position. A preload device (not shown), such as an adjustable support, an adjustable electromagnetic or inductive field, or other means, may be included for changing the preload of the reed-like member on the seat and/or the stiffness of the reed-like member. The embodiment of FIGS. 3a-3c functions similarly to the embodiments of FIGS. 1a-1c, and operates to convert a steady flow of gas or liquid, illustrated by the solid arrow, into a pulsating flow of gas or liquid, as illustrated by the dashed arrows. As with the prior embodiment, the reed-like member may oscillate between positions closer to and farther from the seat without contacting the seat. The reed-like member may also be positioned differently than shown.

A plurality of nozzles or devices as disclosed herein may be arranged in a row along a manifold face as seen with compressed air nozzles in industry. The oscillating portion of the device, such as the oscillating ball or reed-like member, may be disposed in the manifold to feed pulsating air to all nozzles, or each nozzle may have a dedicated oscillating portion. The manifold may be considered to be a “block” system.

A nozzle, as discussed herein, may have an outlet with various shapes. Typically the nozzle outlet will be a round opening so as to provide a cylindrical or cone shaped flow or pulsating air, but the opening may alternatively be square, oval, or other shapes. As a further alternative, the nozzle opening may be an elongated slot such that the flow of pulsating air is more sheet-like. The pulsating portion of the device is upstream of the opening such that the entire sheet-like flow of air pulsates. The present invention may be combined with traditional nozzles such that portions of the overall flow pulsate, while other portions are steady. For example, in a system with multiple nozzles, some nozzles may be traditional while others provide a pulsating flow. The devices of the present invention may allow the pulsation feature to be turned on and off, such as by trapping the oscillating member in the open position to turn the feature off.

While discussed generally with respect to a flow of compressed gas, the present invention may also be used with a vacuum, wherein the vacuum is applied to the outlet portion of the flow passage and a pulsating vacuum is created at the inlet. The devices, with appropriate modification, may also be used with flows of liquid, instead of gas, or flows of a mixture of liquid and gas.

FIG. 4 shows yet a further alternative embodiment of a device 38 for creating a pulsating flow of gas or liquid. The Figure provides a cut away view of a body with an inlet 39 and an outlet 40. A central portion 41 is a loop shaped passage in fluid communication with the inlet 39 and outlet 40. A ball or roller 42 is disposed in the passage 41 and under appropriate flow conditions moves around the passage such that it intermittently blocks and unblocks the portion of the passage between the inlet and outlet. As will be clear to those of skill in the art, the roller 42 does not completely block the passage, but instead just fluctuates the flow.

As discussed above, each of the embodiments of the present invention may further include an element or elements for adjusting the pulsation of the flow and/or to turn the pulsation feature on and off. A few variations on such elements will now be discussed.

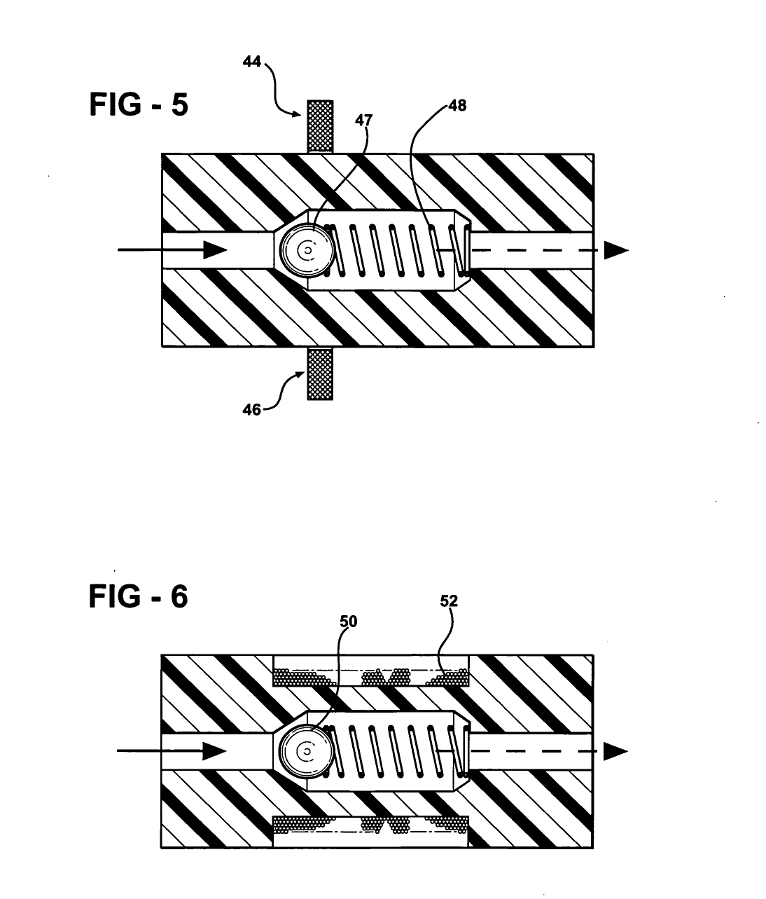

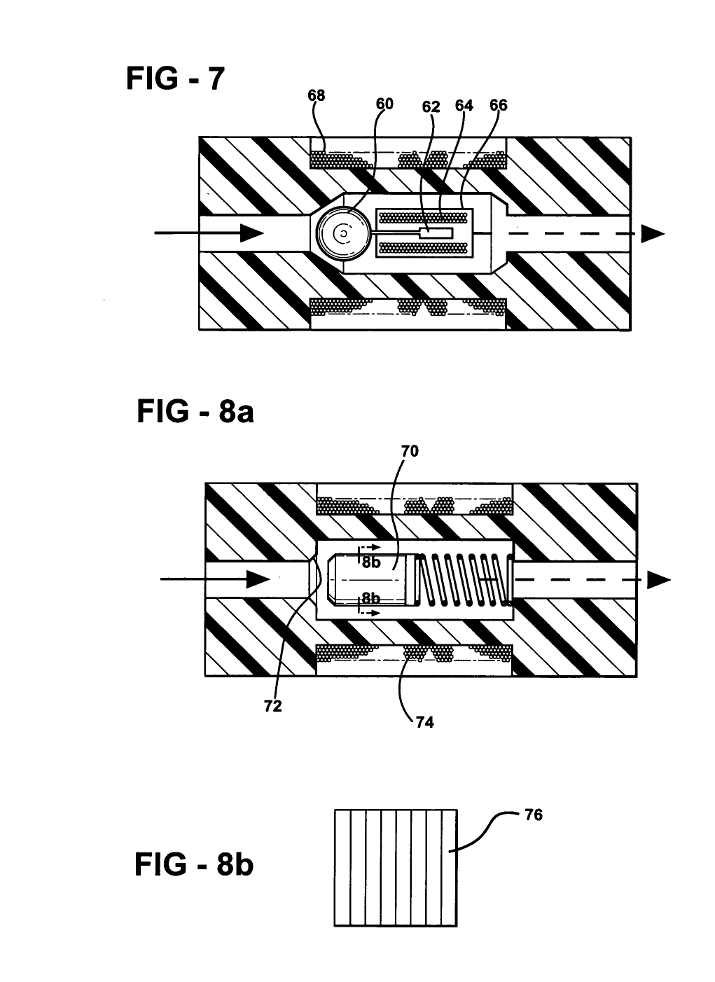

FIG. 5 illustrates a modified version of the present invention designed to allow the effective spring rate to be adjusted, or to act as an electric solenoid valve to control actual flow. In FIG. 7, the device includes magnets 44 and 46 that interact with the moving ball 47 so as to alter the air flow. The magnets 44 and 46 impose a force on the ball which may increase or decrease the effective spring rate of the spring 48. For example, the magnets may urge the ball 47 towards the seat or away from the seat, so as to assist or oppose the spring 48. The magnets may be individual magnets or part of an assembly or larger magnet. The magnets may be permanent or electromagnetic. Preferably, the magnets are movable along the device so as to adjust their effect on the ball. The ball 47 is preferably formed of or includes ferromagnetic material.

FIG. 6 illustrates another embodiment of the present invention. This embodiment is similar to the embodiment of FIG. 1, and includes an oscillating ball 50. The device also includes a coil 52 surrounding the spring and ball, operable to inductively or magnetically alter the oscillation of the ball. The ball is preferably partially or completely formed of a ferromagnetic material, but may also be non ferrous.

FIG. 7 shows another alternative embodiment in which a ball 60 has a piston 62 interconnected therewith. The piston is disposed inside a coil 64 in a housing 66. The piston 62 is formed partially or completely of a ferromagnetic material such that the coil can inductively or magnetically move the piston, thereby moving the ball, which may or may not be ferromagnetic. A spring, though not illustrated, may also be provided for supporting the ball. An outer coil 68 may also be provided, which may be used in addition to or in place of the inner coil 64. The outer coil could be replaced by permanent magnets. The design of FIG. 7, and variations thereon, allow for control of ball motion. The coil and magnet approaches of FIGS. 6 and 7 may also be applied to the reed-like member, to allow additional control.

The oscillating “ball” used in various embodiments of the present invention may be spherical, or may have other shapes. For example, a roughened sphere or sphere with protrusions may be better suited. Alternatively, the “ball” may be ovoid or other shapes. An elongated member may be beneficial in some applications, since the longer shape is more easily guided in the passageway.

FIG. 8 shows an alternative version of the embodiment of FIG. 6, wherein the blocking member is a generally cylindrical slug 70 rather than a ball. The slug 70 may have a tapered end for improved engagement with the seat 72. This embodiment may include a coil 74, which functions as discussed above. The slug may have a circular cross section, or other shapes, such as square or rectangular. FIG. 8b shows a cross section of a slug which is generally square and formed of a stack of ferrous or ferromagnetic laminates 76. Alternatively, any of the slugs or balls herein may be jacketed in a highly conductive material such as copper or gold. In one version, a ferrous ball or slug is jacketed in copper.

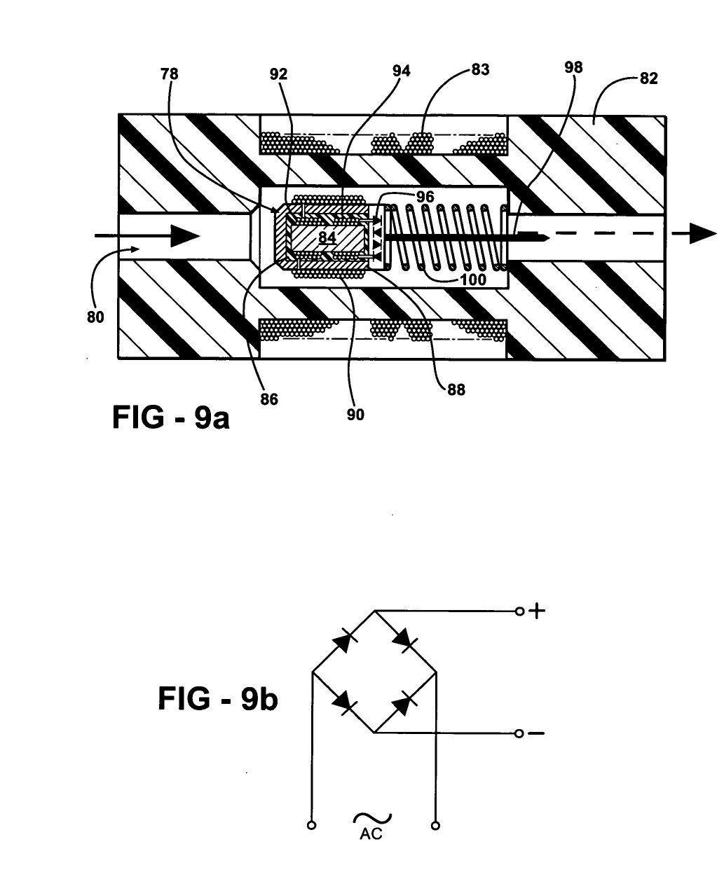

FIG. 9A shows yet a further embodiment of the present invention. As known to those of skill in the art, flows of compressed air, gas or liquid often create a charge, similar to static electricity, on a surface contacted by the flow of compressed air. For some applications, this static charge is undesirable, since it may attract dust or debris. The embodiment of FIG. 9A may be used to neutralize or ionize a flow of gas or liquid. The illustrated version includes a slug 78 that moves within a passage 80 in a housing 82 and generates electricity. In this embodiment, housing 82 includes a field winding or stator winding 83 surrounding the passage 80 and slug 78. The slug has an inner ferrous core 84 which is covered by a plastic layer 86, which is covered by an iron layer 88. An armature coil 90 surrounds the slug so as to move with the slug as it oscillates within the field winding 83. As known to those of skill in the art, if the field winding is energized, the movement of the slug will cause a current to flow in the armature coil. As shown, a primary coil 92 and a secondary coil 94 are each disposed in the plastic layer 86, and are side by side in this version, though other arrangements are possible. The armature coil 90 is connected to the primary coil 92, and the primary and secondary coils, along with the iron core, act as a transformer to raise the voltage. The ends of the secondary coil may be interconnected with a full wave bridge 96 which may be used to rectify the alternating current into a direct current. A schematic of the bridge is shown in FIG. 9B. The positive and negative outputs of the bridge 96 are preferably connected with an electrode or tail 98 which extends from the slug 78. The tail 98, in the illustrated version, is coaxial with the passage 80, but it may take other forms, as will be clear to those of skill in the art. The other output of the bridge is preferably connected to the spring 100. This arrangement may be operable to ionize or neutralize a flow of gas or liquid. It may also be used to act on particles in the flow, so as to serve as a filter or assist with filtering.

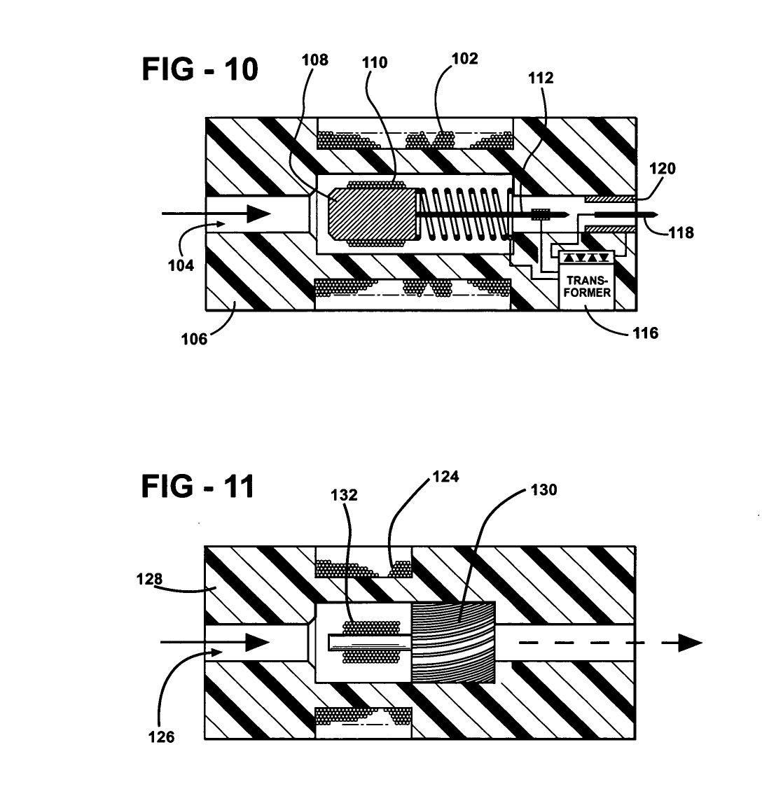

FIG. 10 shows another version of the present invention operable to neutralize or ionize a flow of gas or liquid. In this version, a field winding 102 surrounds a passage 104 in a housing 106. The slug 108 is preferably ferrous and has a coil 110 wrapped around it, serving as an armature winding. The ends of the coil are connected to the tail 112 and spring 114, which are wired to a transformer 116. The output of the transformer is connected to a discharge device including a central electrode 118 and a surrounding electrode 120 positioned in the passage 104. In the versions of FIGS. 9A or 10, a capacitor may be placed in series between the armature and the primary.

FIG. 11 shows a portion of another version of the present invention in which a rotary or turbine generator is disposed in the flow path to generate electricity, which may be used for a variety of purposes, including neutralizing or ionizing a flow of gas or liquid. The device includes a field winding 124 surrounding a passage 126 in a housing 128. An impeller or turbine 130 is positioned in the passage such that the flow of gas or liquid rotates the turbine 130. An armature winding 132 is disposed on a shaft connected to the turbine 130 such that they rotate together. As will be clear to those of skill in the art, rotation of the armature winding inside an energized field winding generates electricity. Some embodiments may include a transformer and discharge device as in FIG. 10. There are several alternative variations. In one, the field winding is replaced with permanent magnets. In another, the armature winding is replaced with permanent magnets and the electricity is generated in the field winding. The device may also be set up like a standard AC machine. The device may further include a mechanism for pulsating the flow in accordance with any of the embodiments herein.

Embodiments of the present invention which utilize an outer coil, which may be energized, can also be used to sense the position of the slug or ball relative to the outer coil. As the position of the slug or ball changes relative to the outer coil, the inductance of the outer coil changes, which may be sensed in a variety of ways, including looking at current rise time. The characteristics of the coil, such as current rise time, may be correlated with the position of the slug or ball such that position may be determined later without direct observation or measurement.

The various embodiments of the present invention may be used in a variety of applications, including clean room dust removal systems, cleaning systems, drying systems, etc, with one or more nozzles or sheets of moving gas or air.

As mentioned above, various embodiments of the present invention may be used with fluids as well as or instead of gas. For example, a fluid control valve such as shown in FIGS. 1a-1c may be used with a liquid or fluid flowing through the passage so as to cause a check ball to oscillate thereby pulsating or vibrating the flow of liquid. As will be clear to those of skill in the art, the flow passage, ball, seat and spring may have to be designed differently depending on the viscosity of the fluid, flow rate, the pressure and other factors. Typically, the spring will need to be much stiffer than for a gas-based flow control device.

Gas and fluid control devices described in the present invention may be used in a variety of applications. FIG. 12 shows an application in a drill bit 140 with a passage 142 extending along the body of the drill bit. The passage 142 includes an area with a check ball 144 and a spring 146 designed to oscillate the flow of fluid through the passage 142. Typically, a liquid such as a cutting fluid will be passed through the passage at high pressure. The ball 144 and spring 146 will oscillate to create pulsations in the flow. The flow of liquid is designed to move debris from the flutes of the drill bit, as shown. Any design of fluid control device as discussed herein may be used in this application, and it may be used with liquid or gas, though a liquid is preferred. The control device may be provided in the drill bit, as shown, or upstream such as in a drill head or fluid supply device.

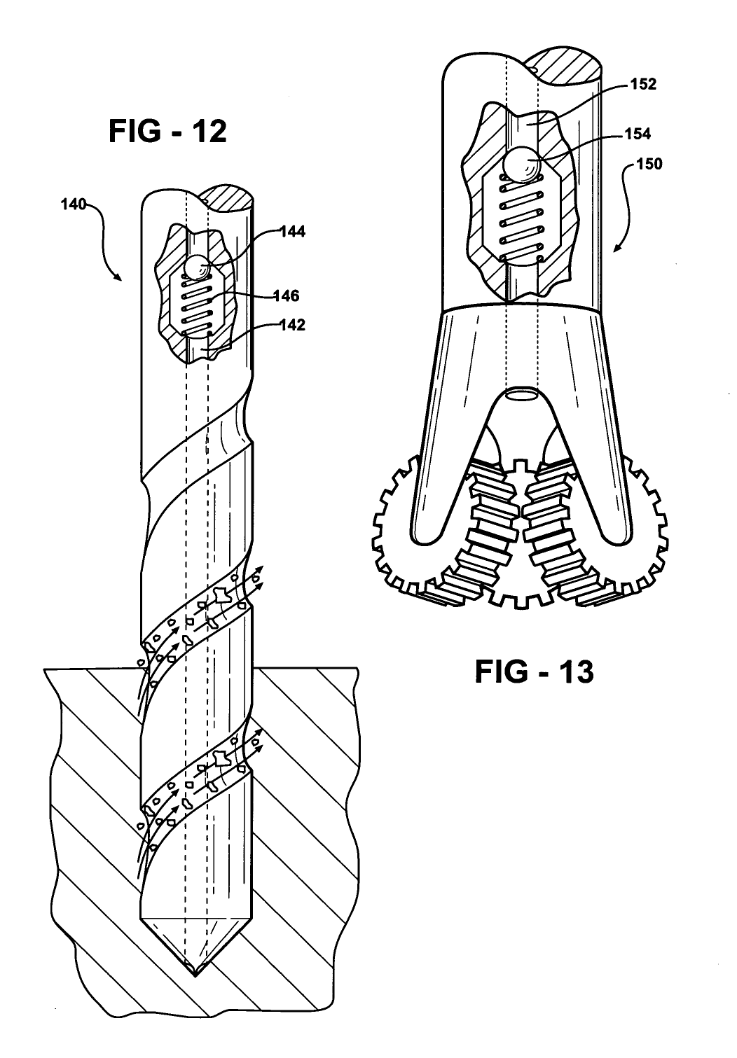

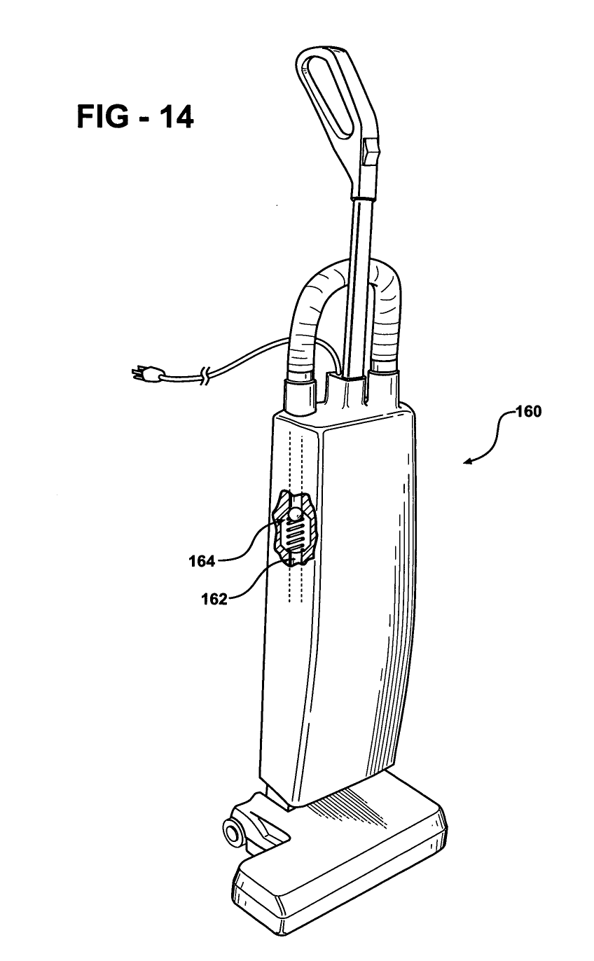

FIG. 13 shows a drill head such as used in oil drilling. As known to those of skill in the art, the drill heads have complex cutting heads, such as the gear-like head shown. In this embodiment, the drill head 150 has a fluid or gas passage 152 defined therethrough with a fluid interrupting element such as ball 154 disposed in the passage for pulsating the flow. Again, the fluid control device may be placed in the drill head or upstream of the position illustrated. Multiple such fluid control devices may be provided. Any of the designs discussed herein may be used in this drill head, and may be used with fluid or gas, though fluid is preferred.

FIG. 14 shows a vacuum cleaner 160 wherein a suction passage 162 includes a fluid control device of the present invention, as shown at 164. As will be clear to those of skill in the art, the present invention may be used in suction as well as pressure flow systems. The oscillation caused by the device 164 will help in clearing the suction passage 162 of debris, and may assist in vacuum performance.

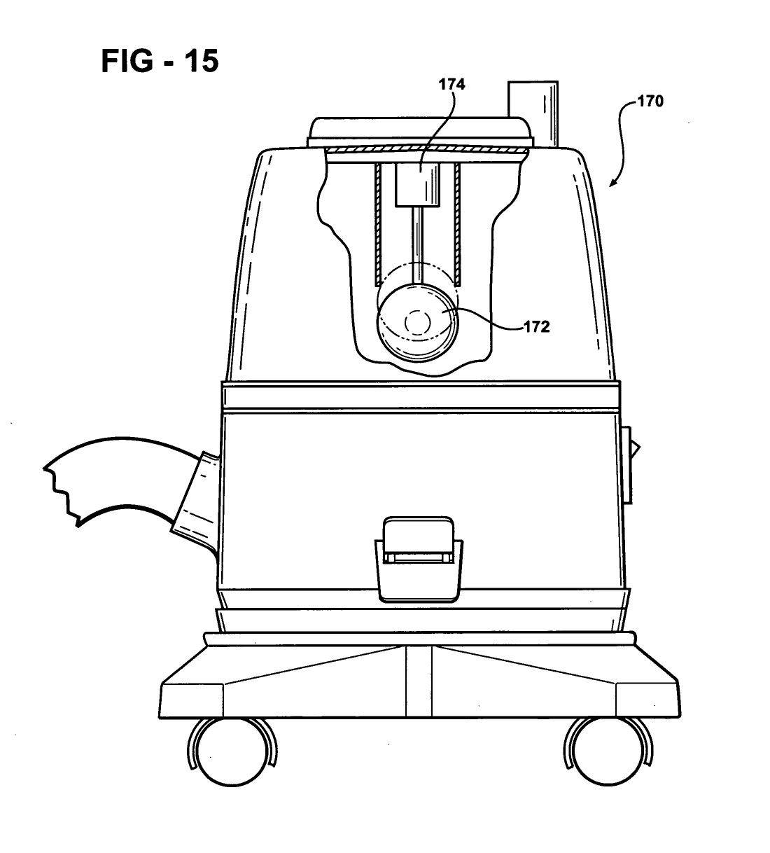

FIG. 15 shows a garage-type vacuum 170. As known to those of skill in the art, vacuums such as these typically have a check ball provided at the main intake of the blower motor, designed such that if the vacuum 170 falls over or if a liquid level inside the vacuum rises above a certain level, the ball moves into a position closing off the intake to the vacuum motor. Alternatively, the ball may be in the outlet. In the modification according to the present invention, a check ball 172 is provided attached to a solenoid or other control device 174 that is operable to oscillate the ball 172 so as to pulsate the vacuum flow and/or shake the filter. A passive device such as shown in FIG. 14 may be used alternatively or in addition to the device of FIG. 15.

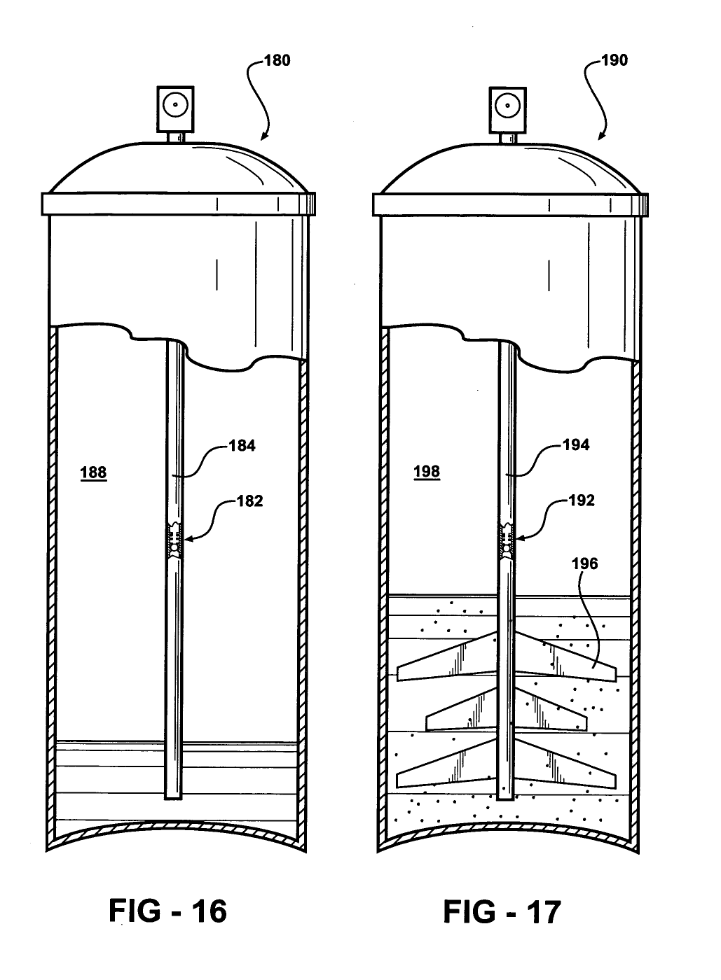

FIGS. 16 and 17 show aerosol spray cans 180 and 190 with fluid control devices 182 and 192, respectively, disposed in the spray tubes 184 and 194, respectively. The fluid control devices 182 and 192 are preferably designed so as to oscillate the flow of liquid in the tubes 184, 194. This may serve several purposes. The oscillation may serve to vibrate the flow of paint so as to improve the flow or application of the paint. The oscillation may also serve to clear clogs from the tube or spray mechanism. The oscillation mechanism may also serve to vibrate the tubes, thereby serving to help stir the liquid in the spray cans. In the spray can of FIG. 19, fins 196 are provided extending into the liquid to be sprayed, so as to assist in the vibration of the liquid. This may help to suspend particles in the paint, such as metallic paint particles. Preferably, higher pressures are used with the present invention than in a typical spray can. As such, the spray cans 180 and 190 are shown to be larger with a very large gas space 188 and 198 so as to provide higher gas capacitance. Spray cans may also be designed wherein part of the gas passes through an alternative passage with a fluid control device in that passage instead or in addition to the fluid control devices illustrated. This would create a combined flow of gas and liquid. As a further alternative, fluid control devices may be provided in the spray heads instead of or in addition to the fluid control devices shown.

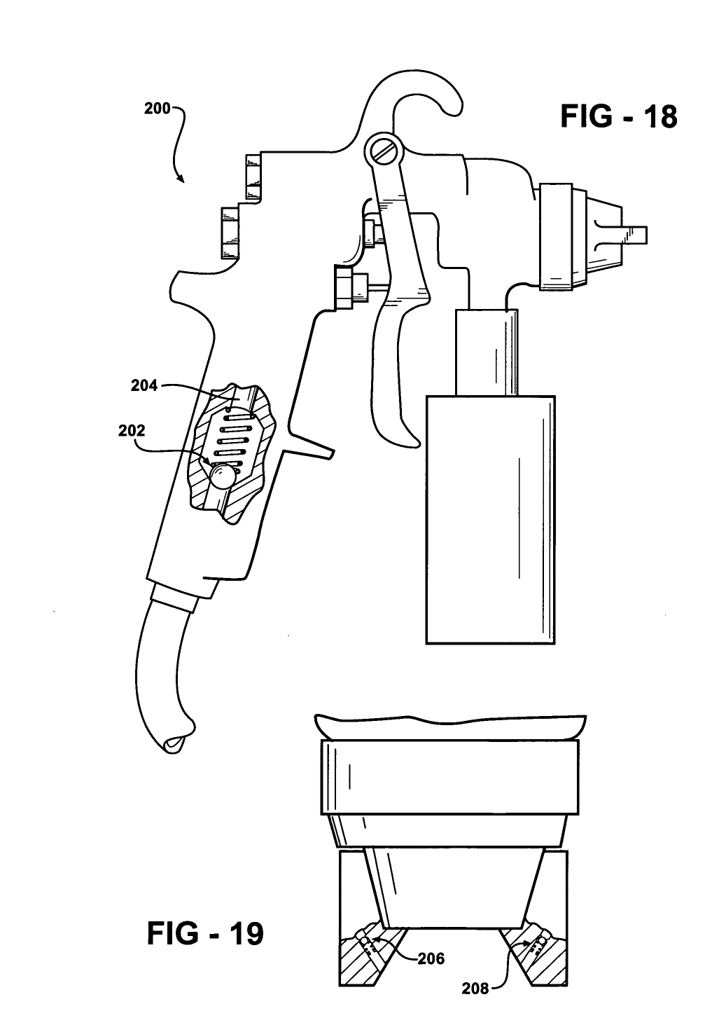

FIG. 18 shows a spray gun 200 with a flow control device 202 disposed in the gas passage 204 for oscillating the flow of gas through the spray gun 200. This may serve to pulsate the flow so as to improve the flow of paint, unclog the nozzle, and other purposes. FIG. 19 shows the provision of flow control devices 206 and 208 in the nozzle portion of the spray gun 200. These may be used instead of or in addition to the flow control device 202.

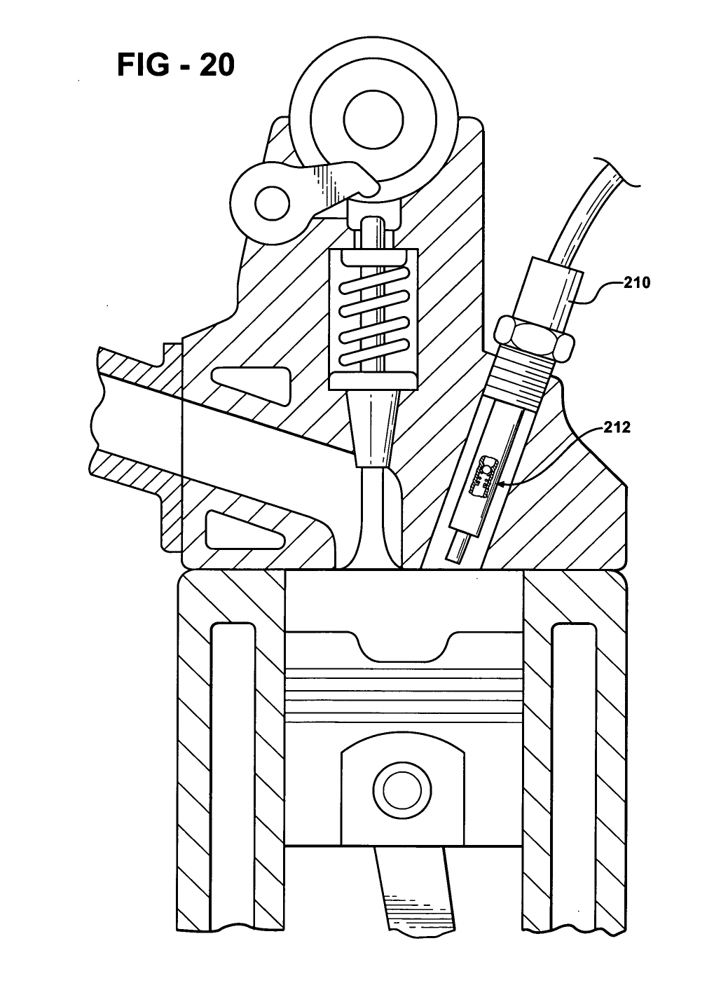

FIG. 20 shows a cross-section of an internal combustion engine with a fuel injector 210 with a fluid control device 212 in the fuel passage. Again, the fluid control device is preferably tuned so as to pulsate the flow of fuel through the fuel injector. The device may also be mounted within the recirculating fuel rail.

As will be clear to those of skill in the art, the fluid control devices of the present invention may be used in a wide variety of applications. In one example, one or more nozzles or a sheet of oscillating gas or liquid flow may be position so as to impinge on the back of a belt of a belt sander so as to shake the belt, thereby dislodging dust. A pulsating flow may impinge on the back surface of the belt or the sanding surface on the non-engaged part of the belt loop. In another application, fluid control devices may be provided to provide a pulsating flow of liquid or gas onto the side or face of a saw blade, thereby vibrating the teeth to improve cutting or clean the teeth. The saw blade may also be vibrated by the use of magnets, according to an alternative approach.

Another use for the present invention is in pneumatic air tools. For example, a fluid control device may be provided in a line for a pneumatic device to pulsate the flow of compressed air. In one application, this is used with a drill so as to convert the drill to a hammer-drill-like device. This may also be used in other air tools, including impact wrenches and other devices.

In another application, pulsating flow devices according to the present invention are used with pipes, plumbing, or air ducts so as to clean or assist in flow. For example, a pulsating liquid or gas flow device may be teed into a line so as to provide a pulsating flow into the pipe to assist in cleaning. This can also vibrate the pipe or duct walls.

The devices according to the present invention may be used in a wide variety of applications, such as liquid blasting devices for cleaning purposes, such as pressure washers and high-pressure cleaning devices. Another use is in drain cleaning devices wherein a flow of pressurized fluid is used to clear a drain. Pulsating flow may assist in clearing the drain.

In any of the applications of the present invention, a flow control device may be provided in an alternative passage so as to be selectively used. For example, a main flow passage may be provided in parallel with a flow passage including a fluid control device according to the present invention. If the user wishes to switch from steady flow to pulsating flow, the valve may be turned so as to switch the flow from the main passage to the alternative passage including a fluid control device. Other ways of selectively using the present invention may also be useful, such as trapping fluid control devices in and on or off position so as to block or allow flow. The present invention may also be used in backflow devices so as to pulsate flow or vacuum during a backflow, backflush or cleaning procedure.

As will be clear to those of skill in the art, the herein disclosed embodiments of the present invention may be altered in a variety of ways without departing from the scope or teaching of the present invention.

I claim:

1. A device for creating a pulsating flow of gas or fluid, the device comprising:
a body having a flow passage defined therethrough;
a flow interrupting element disposed in the passage, the flow interrupting element having a flow interrupting position wherein the element at least partially blocks the passage and an open position wherein the flow passage is less blocked than when the element is in the flow interrupting position; and
a biasing element that biases the flow interrupting element into the flow interrupting position;
wherein a flow of gas or fluid entering the flow passage impinges on the flow interrupting element such that the flow interrupting element oscillates between the flow interrupting position and the open position, thereby creating a pulsating flow of gas or fluid.

2. The device according to claim 1, wherein:
the flow interrupting element is a ball.

3. The device according to claim 2, wherein:
the flow passage has an inlet portion, a central portion and an outlet portion, the portions being interconnected and continuous, a seat being defined where the inlet portion connects with the central portion; and
the ball is disposed adjacent the seat when in the flow interruption position.

4. The device according to claim 3, wherein:
the biasing element is a coil spring biasing the ball toward the seat.

5. The device according to claim 3, wherein:
the ball is at least partially formed of a ferromagnetic material;
the device further comprising a coil disposed around the flow passage, the coil operable to exert a force on the ball.

6. The device according to claim 1, wherein
flow interrupting element includes a first coil having a pair of ends;
the device further comprising a second coil surrounding the flow passage; and
a ionizing element in electrical communication with one end of the coil.

7. The device according to claim 1, wherein:
the biasing element includes a piston interconnected with the flow interrupting element and a coil operable to move the piston.

8. The device according to claim 1, wherein:
the device includes a reed-like member having a compliant body and a free end, the free end being the flow interrupting element and the compliant body being the biasing element.

9. An apparatus comprising:
a body having a flow passage defined therethrough, the flow passage having an inlet portion, a central portion and an outlet portion;
a flow interrupting element disposed in the passage, the flow interrupting element having a flow interrupting position wherein the element at least partially blocks the passage and an open position wherein the flow passage is less blocked than when the element is in the flow interrupting position; and
a biasing element that biases the flow interrupting element into the flow interrupting position;
wherein a flow of gas or fluid entering the flow passage impinges on the flow interrupting element such that the flow interrupting element oscillates between the flow interrupting position and the open position, thereby creating a pulsating flow of gas or fluid.

10. The apparatus according to claim 9, further comprising:
a drill bit having a drilling tip with an opening defined therein, the flow passage being in fluid communication with the opening in the drill bit tip.

11. The apparatus according to claim 9, further comprising:
a drill head with an opening defined therein, the flow passage being in fluid communication with the opening in the drill head.

12. The apparatus according to claim 9, further comprising:
a vacuum cleaner having a suction inlet and a vacuum source, the inlet portion of the flow passage being in fluid communication with the suction inlet and the outlet portion of the flow passage being in fluid communication with the vacuum source.

13. The apparatus according to claim 12, wherein:
the biasing element comprises a solenoid operable to move the flow interrupting element.

14. The apparatus according to claim 9, wherein the apparatus is a spray can for spraying a liquid thru a nozzle, the spray can further comprising:
a container for containing the liquid and a propellant;
a spray outlet for providing liquid to the nozzle;
a spray tube having a first end in fluid communication with the spray outlet and a second end extending into the container;
the body with the flow passage comprising part of the spray tube.

15. The apparatus according to claim 14, wherein:
the flow interrupting element comprises a ball; and
the biasing element comprises a spring.

16. The apparatus according to claim 14, further comprising:
at least one fin interconnected with the spray tube.

17. The apparatus according to claim 9, wherein the apparatus is a paint spray gun, the apparatus further comprising:
a spray head with an outlet nozzle; and
an inlet line for providing compressed air to the spray head, the body having the flow passage forming part of the inlet line.

18. The apparatus according to claim 9, wherein the apparatus is a paint spray gun, the apparatus further comprising:
a spray head with an outlet nozzle; and
an inlet line for providing compressed air to the spray head;
the body having the flow passage being disposed in the outlet nozzle of the spray head.

19. The apparatus according to claim 9, wherein the apparatus is a fuel injector, the body having the flow passage forming part of the fuel injector such that fuel flowing thru the injector is pulsated.
